(19) United States
(12) Patent Application Publication
(10) Pub. No.: US 2003/0016213 A1
(43) Pub. Date: Jan. 23, 2003

(54) Optical display device

(76) Inventor: Samson Huang, Saratoga, CA (US)

Correspondence Address: Timothy N Trop, Trop Pruner Hu & MIles PC, 8554 Kathy Freeway Ste 100, Houston, TX, 77024, US

(21) Appl. No.: 09/493,319

(22) Filed: Jan. 28, 2000

(51) Int. Cl. G09G 5/00

(52) U.S. Cl. 345/204

(57) ABSTRACT

A method includes providing a capacitor to maintain a terminal voltage of a pixel cell near a predetermined voltage. A memory is provided to store a digital indication of the predetermined voltage, and during a refresh operation, the digital indication is converter into an analog voltage to update a charge on the capacitor.

### BACKGROUND

The invention generally relates to an optical display device, such as a silicon light modulator (SLM), for example.

Referring to FIG. 1, a silicon light modulator (SLM) 1 may include an array of LCD pixel cells 25 (arranged in rows and columns) that form corresponding pixels of an image. To accomplish this, each pixel cell 25 typically receives an analog voltage that controls the optical response of the pixel cell 25 and thus, controls the perceived intensity of the corresponding pixel. If the pixel cell 25 is a reflective pixel cell, the level of the voltage controls the amount of light that is reflected by the pixel cell 25, and if the pixel cell 25 is a transmissive pixel cell, the level of the voltage controls the amount of light that passes through the pixel cell 25.

There are many applications that may use the SLM 1. For example, a color projection display system may use three of the SLMs 1 to modulate red, green and blue light beams, respectively, to produce a projected multicolor composite image. As another example, a display screen for a laptop computer may include an SLM 1 along with red, green and blue color filters that are selectively mounted over the pixel cells to produce a multicolor composite image.

Regardless of the use of SLM 1, updates are continually made to the SLM cells 20 to refresh or update the displayed image. More particularly, each pixel cell 25 may be part of a different SLM cell 20 (an SLM cell 20a, for example), a circuit that includes the pixel cell 25 and typically includes a capacitor 24 that stores a charge to maintain the appropriate voltage on the pixel cell 25. The SLM cells 20 typically are arranged in a rectangular array 6 of rows and columns.

The charges that are stored by the SLM cells 20 typically are updated (via row 4 and column 3 decoders) in a procedure called a raster scan. The raster scan is sequential in nature, a designation that implies the SLM cells 20 of a row are updated in a particular order such as from left-to-right or from right-to-left.

As an example, a particular raster scan may include a left-to-right and top-to-bottom “zig-zag” scan of the array 6. More particularly, the SLM cells 20 may be updated one at a time, beginning with the SLM cell 20a that is located closest to the upper left corner of the array 6 (as shown in FIG. 1). During the raster scan, the SLM cells 20 are sequentially selected (for charge storage) in a left-to-right direction across each row, and the updated charge is stored in each SLM cell 20 when the SLM cell 20 is selected. After each row is scanned, the raster scan advances to the leftmost SLM cell 20 in the next row immediately below the previously scanned row.

During the raster scan, the selection of a particular SLM cell 20 may include activating a particular word, or row, line 14 and a particular bit, or column, line 16, as the rows of the SLM cells 20 are associated with row lines 14 (row line 14a, as an example), and the columns of the SLM cells 20 are associated with column lines 16 (column line 16a, as an example). Thus, each selected row line 14 and column line 16 pair uniquely addresses, or selects, a SLM cell 20 for purposes of transferring a charge (in the form of a voltage) from a signal input line 12 to the capacitor 24 of the selected SLM cell 20.

As an example, for the SLM cell 20a that is located at pixel position (0,0) (in cartesian coordinates), a voltage that indicates a new charge that is to be stored in the SLM cell 20a may be applied to one of the video signal input lines 12. To transfer this voltage to the SLM cell 20a, the row decoder 4 may assert (drive high, for example) a row select signal (called ROW₀) on a row line 14a that is associated with the SLM cell 20a, and the column decoder 3 may assert a column select signal (called COL₀) on column line 16a that is also associated with the SLM cell 20a. In this manner, the assertion of the ROW₀ signal may cause a transistor 22 (of the SLM cell 20a) to couple a capacitor 24 (of the SLM cell 20a) to the column line 16a, and the assertion of the COL₀ signal may cause a transistor 18 to couple the video signal input line 12 to the column line 16a. As a result of these connections, the voltage of the video signal input line 12 is transferred to the capacitor 24. The other SLM cells 20 may be selected for charge updates in a similar manner.

Typically, there are two types of charge updates: a frame update is used to update the intensities of the pixel cells 25 for a new frame of the displayed image and a refresh update is used to maintain the charge that is stored on the capacitor 24 between frame updates. Without the refresh updates, the pixels intensities may fade due to charge leakage and/or charge sharing.

Because the array 6 might be quite large, the number of signal lines 12 typically is considerably smaller than the number of column lines 16. Therefore, the signal lines 12 typically are used to sequentially access the SLM cells 20 K cells at a time (where “K” represents the number of signal lines and typically is less than the number (M) of columns) at a time by activating the appropriate transistors 18. Because only K bit lines 16 are driven with new values (and thus, only K transistors 18 are activated), the remaining column lines 16 are in a tri-state condition and are coupled to the nonselected capacitors 24 of the row. Therefore, charge sharing typically occurs between the capacitors 24 and the tri-stated column lines 16.

One way to minimize the effect of the charge sharing is through the refresh updates. Another way to minimize the effect of charge sharing is to ensure that each capacitor 24 has a large capacitance. However, large capacitances typically imply large capacitors that occupy a substantial amount of the silicon on which the SLM cell 20 is fabricated, leaving little space for other circuitry of the SLM cell 20.

Thus, there is a continuing need for an arrangement that addresses one or more of the problems that are stated above.

### BRIEF DESCRIPTION OF THE DRAWING

FIG. 1 is a schematic diagram of a silicon light modulator (SLM) according to the prior art.

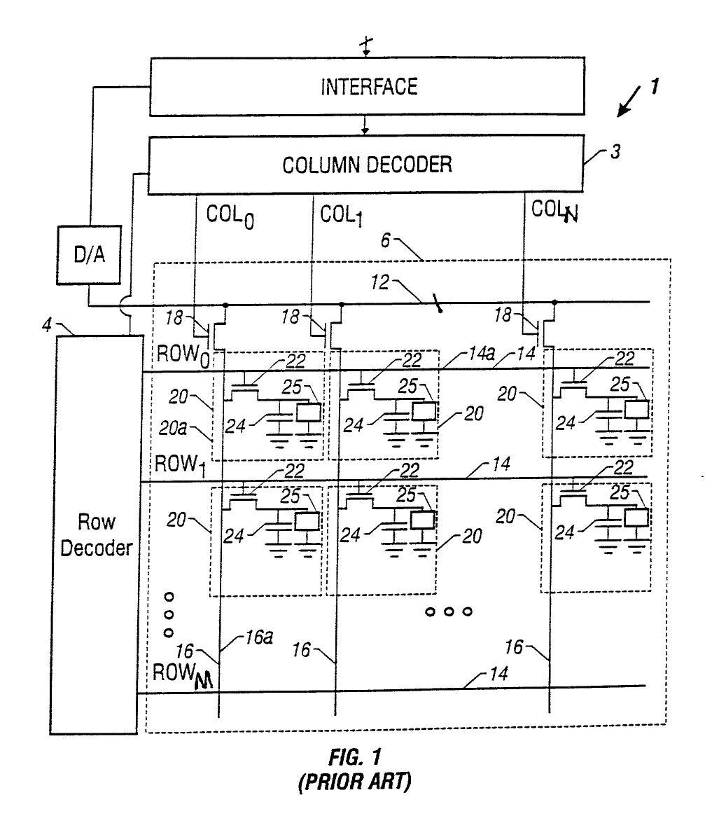

FIG. 2 is a schematic diagram of a silicon light modulator cell according to an embodiment of the invention.

FIG. 3 is a schematic diagram of a silicon light modulator according to an embodiment of the invention.

FIG. 4 is a schematic diagram of an arrangement to form multiple digital-to-analog converters of the SLM according to an embodiment of the invention.

### DETAILED DESCRIPTION

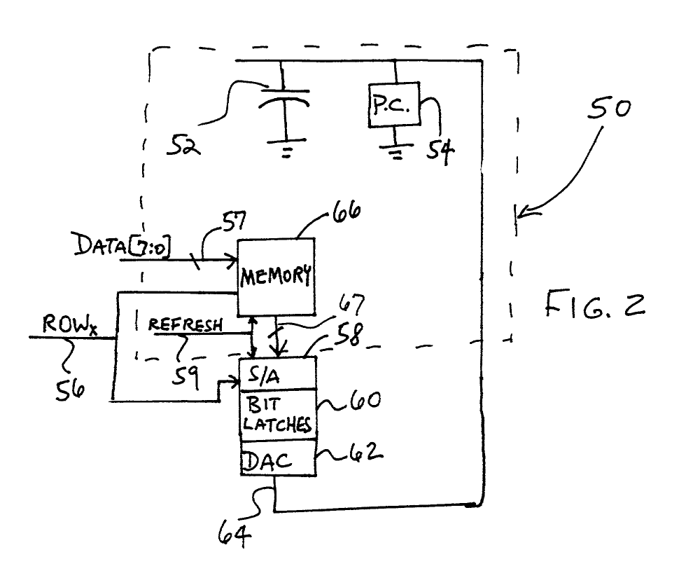

Referring to FIG. 2, an embodiment 50 of an SLM cell in accordance with the invention includes a memory 66 (part of a larger static random access memory (SRAM), for example) that stores a digital indication of a pixel intensity for a pixel cell 54 (of the SLM cell 50). The SLM cell 50 may use a digital-to-analog converter (DAC) 62 to, during a refresh operation, convert the digital indication into an analog voltage to refresh the charge on a capacitor 52 (of the SLM cell 50) that furnishes the terminal voltage to a pixel cell 54 of the SLM cell 50. As an example, in some embodiments, the memory 66 may store eight bits that may indicate up to 256 different pixel intensity levels for the pixel cell 54.

The SLM cell 50 may be one of several SLM cells 50 of a row of an SLM. Due to the above described arrangement, all of the capacitors 52 in the SLM cells 50 of the row may be updated at the same time without coupling any of the capacitors 52 to a tristated bit, or column, line. Therefore, charge sharing between the capacitors 52 and the bit lines of the SLM does not occur, and thus, each capacitor 52 may be smaller than the traditional capacitor of the SLM cell. Furthermore, because the refresh operation is internal to each SLM cell 50, refresh operation may occur more often than conventional arrangements, an advantage that permits the size of each capacitor 52 to be even smaller.

For purposes of updating the memory 66 with a new value that indicates the pixel intensity of the next frame, a word, or row, line 56 that is associated with the row of the SLM cell 50 is asserted (driven high, for example) to cause the memory 66 to load the new data from the corresponding bit lines 57. At this time, sense amplifiers 58 respond to the new bit values to store the new values into bit latches 60 that store the bit values for conversion by the DAC 62. In this manner, the DAC 62 converts the digital value that is indicated by the bits into an analog voltage that appears on an analog line 64 that is coupled to a plate of the pixel cell 54. The other plate of the pixel cell 54 may be coupled to ground.

The refresh operation also uses the sense amplifiers 58, the bit latches 60 and the DAC 62. In this manner, a refresh signal line 59 may be asserted (driven high, for example) to indicate the refresh operation. When the word line 56 is also asserted, the sense amplifiers 58 generate signals to store bits (in the bit latches 60) that indicate the value that is stored in the memory 66. The DAC 62 then converts the digital value that is indicated by the bits into the analog voltage that appears on the line 64.

As an example, in some embodiments, the SLM cell 50 may be refreshed at a rate of approximately 1 KHz to minimize the appearance of an artifact, or error, when the SLM cell 50 is updated with the intensity value for the next frame. In some embodiments, the frame update occurs between the read cycle of the refresh operation. Therefore, for purposes of writing an indication of a new pixel intensity in the memory 66 for the next frame, the write operation may be synchronized with the refresh clock signal and then written into the memory 66 between two refresh cycles. Because the rate at which the memory 66 is updated is much lower than the refresh rate, there is always enough cycle to write new data into the memory 66.

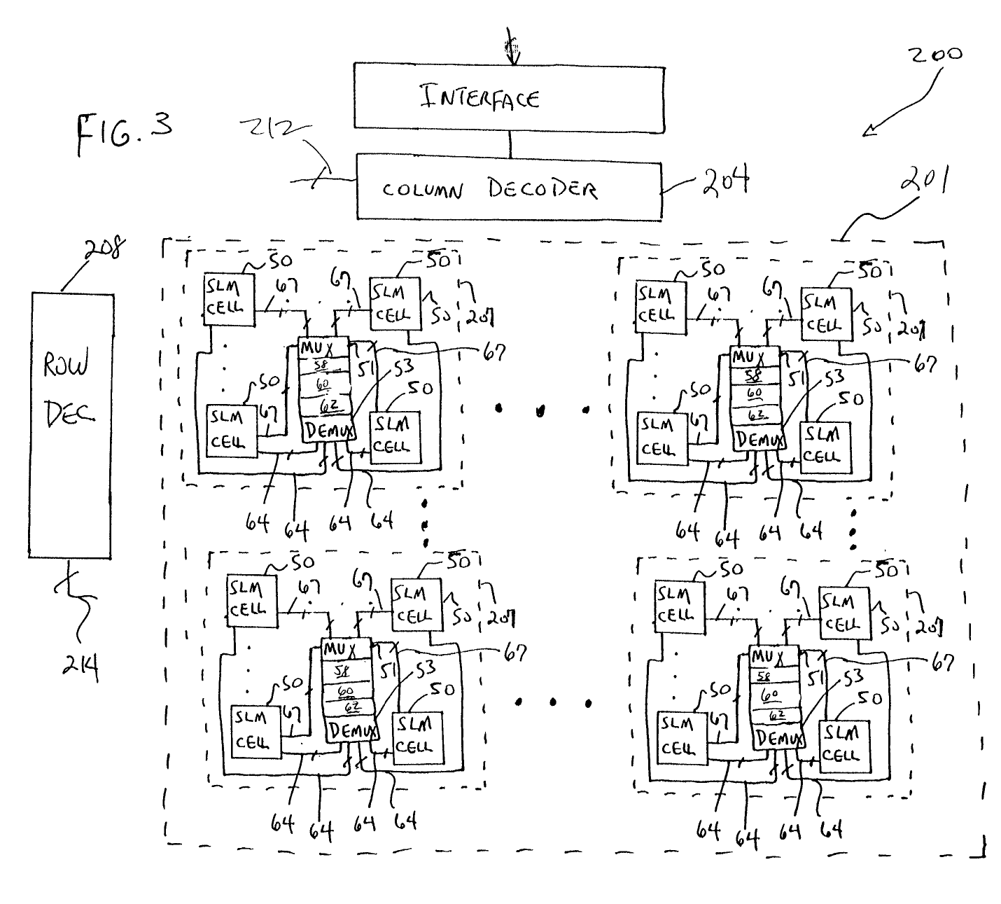

Referring to FIG. 3, the SLM cell 50 may be used in an SLM 200 and may be one of several SLM cells 50 that are arranged in rows and columns. In some embodiments, the SLM 200 may include a row decoder 208 that includes control lines 214 to select a particular row of SLM cells 50 for raster scan updates or a refresh operation, and the SLM 200 may include a column decoder 204 that includes control and data lines 212 to update the memories 66 of a group of the SLM cells 50 of a particular row. In this manner, in some embodiments, to perform a raster scan, the row decoder 208 may select the SLM cells 50 one row at a time. For each selected row, the column decoder 204 selects a group of the SLM cells 50, updates the memories of the selected group of SLM cells 50 and continues this process until the memories of all of the SLM cells 50 of the selected row have been updated. Other arrangements are possible.

In some embodiments of the invention, the SLM cells 50 may be arranged in a rectangular array 201 of units 207. In this manner, each unit 207 may include a block of thirty-two columns by sixteen rows of SLM cells 50. The SLM cells 50 of a particular unit 207 share sense amplifiers 58, bit latches 60 and DACs 62 that function as described above. A multiplexer 51 (of each unit 207) selectively couples the SLM cells 50 of a particular row of the block to the sense amplifiers 58 to perform a particular refresh operation, for example. A demultiplexer 53 (of each unit 207) selectively couples the output terminals 64 to the selected row of SLM cells 50 to complete the particular refresh operation, for example. To accomplish these features, each SLM cell 50 is coupled to the multiplexer 51 of its unit 207 via conductive lines 67.

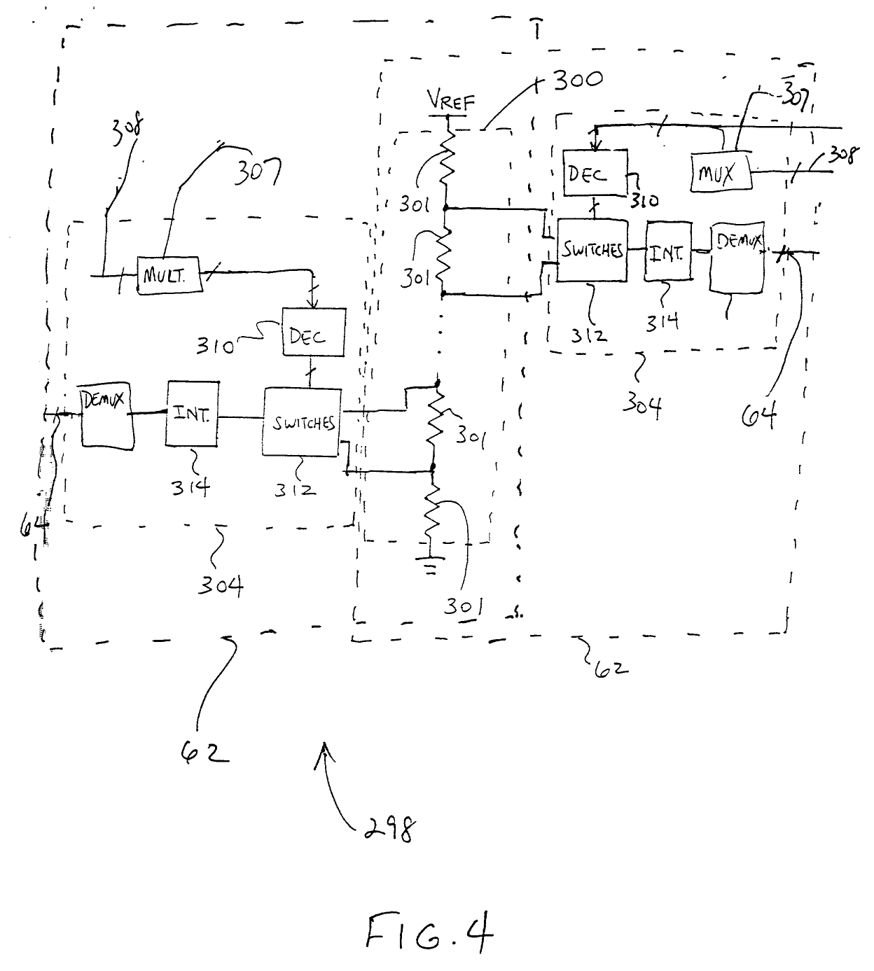

Referring to FIG. 4, in some embodiments, the DACs 62 for a particular unit 207 may be part of a circuit 298. The circuit 298 may be associated with a block of thirty-two columns by sixteen rows of SLM cells 50. In this manner, in each refresh operation, the circuit 298 operates on the associated SLM cells 50 that are in a particular row. Thus, for the example above, in some embodiments of the invention, the circuit 298 performs the digital-to-analog conversions for thirty-two SLM cells 50 at time.

As an example, in some embodiments of the invention, the circuit 298 may include a resistor divider 300 that is formed from resistors 301 that are serially coupled between a reference voltage (called V_{REF}) and ground. The terminals of the resistors 301 provide reference voltages that the second stages 304 of the various DACs 62 use to furnish their analog signals based on the values that are stored in the respective memories 66. As an example, each second stage 304 may include a mulitplexer 307 that has input terminals 308 that are coupled to receive indications of the bits from the SLM cells 50 of the unit 207. In this manner, each multiplexer 307 is associated with a different column and selects the bits from the memory 60 of an SLM cell 50 of the selected row. The multiplexer 307 directs indications of these bits into a decoder 310. The decoder 310, in turn, operates switches 312 that receive the voltage across one of the resistors 301. The switches 312 furnish an analog voltage that is proportional to the value that is indicated by the bits, and an analog interface 314 scales this voltage before providing the voltage to a demultiplexer 316 that furnishes the scaled analog voltage to the appropriate capacitor 52. Thus, due to the above-described arrangement, each DAC 62 includes the resistor divider 300 (that forms the first stage) and the second stage 304.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. A method comprising:
providing a capacitor to maintain a terminal voltage of a pixel cell near a predetermined voltage;
providing a memory to store a digital indication of the predetermined voltage; and
during a refresh operation, converting the digital indication into an analog voltage to update a charge on the capacitor.

2. The method of claim 1, wherein the memory comprises a static random access memory.

3. The method of claim 1, further comprising:
during the refresh operation, reading the digital indication from the memory.

4. The method of claim 1, further comprising:
during the refresh operation, latching the digital indication.

5. The method of claim 1, further comprising:
updating the memory with another digital indication of another predetermined voltage.

6. A method comprising:
providing capacitors, each capacitor being associated with a different pixel cell to maintain a terminal voltage of the associated pixel cell near a predetermined voltage;
providing memory buffers, each memory buffer being associated with a different one of the pixel cells and storing a digital indication of the associated predetermined voltage;
during a refresh operation, converting the digital indications into analog voltages to update charges on the capacitors.

7. The method of claim 6, wherein the capacitors are associated with a row of pixels.

8. The method of claim 6, wherein the memory buffers comprise a part of a static random access memory.

9. The method of claim 6, further comprising:
during the refresh operation, reading the digital indications from the memory buffers.

10. The method of claim 6, further comprising:
during the refresh operation, latching the digital indications.

11. An light modulator cell comprising:
a pixel cell;
a capacitor to maintain a terminal voltage of the pixel cell near a predetermined voltage;
a memory to store a digital indication of the predetermined voltage; and
a digital-to-analog converter to convert the digital indication into an analog voltage to update a charge on the capacitor during a refresh operation.

12. The light modulator cell of claim 11, wherein the memory comprises a static random access memory.

13. The light modulator cell of claim 11, further comprising:
bit latches; and
sense amplifiers to communicate the digital indication from the memory to the bit latches during the refresh operation.

14. The light modulator cell of claim 10, further comprising:
bit latches to latch the digital indication during the refresh operation.

15. The light modulator cell of claim 11, wherein the memory further is updated with another digital indication of another predetermined voltage.

16. A light modulator comprising:
pixel cells;
capacitors, each capacitor being associated with a different pixel cell to maintain a terminal voltage of the associated pixel cell near a predetermined voltage;
memory buffers, each memory buffer being associated with a different one of the pixel cells and storing a digital indication of the associated predetermined voltage; and
digital-to-analog converters to convert the digital indications into analog voltages to update charges on the capacitors during a refresh operation.

17. The light modulator of claim 16, wherein the capacitors are associated with a row of pixels.

18. The light modulator of claim 16, wherein at least one of the memory buffers comprises a static random access memory.
